(19) United States
(12) Patent Application Publication
(10) Pub. No.: US 2020/0201613 A1
(43) Pub. Date: Jun. 25, 2020

(54) Method, System, and Platform for Implementing an Enterprise DevOps Framework (EDF)

(71) Applicant: Flux7 Labs Inc, Austin, TX (US)

(72) Inventors: Ali Asghar Hussain, Austin, TX (US); Aater Suleman, Austin, TX (US)

(21) Appl. No.: 16/621,172

(22) PCT Filed: Jun. 25, 2018
(86) PCT No.: PCT/IB18/54684

§ 371 Date: Dec. 10, 2019

Related U.S. Application Data
(60) Provisional application No. 62/524,284, filed on Jun. 23, 2017.

(51) Int. Cl. G06F 8/60

(52) U.S. Cl. CPC G06F 8/60

(57) ABSTRACT

A method, system, and platform for implementing an Enterprise DevOps Framework to achieve defined business goals. One or more servers is configured to implement a landing zone, a plurality of pipelines, a plurality of services, a plurality of inspectors, and a plurality of injectors. A selected service from the plurality of services is delivered to the landing zone via one or more of the plurality of pipelines, wherein the selected service is then deployed within the landing zone. The plurality of inspectors is deployed in the landing zone to monitor components of the selected service, as the selected service is delivered through the one or more pipelines and deployed within the landing zone. The plurality of injectors is deployed in the landing zone to insert environment specific information into the selected service, as the selected service is delivered through the one or more pipelines.

The current application is a 371 of international Patent Cooperation Treaty (PCT) application PCT/IB2018/054684 filed on Jun. 25, 2018. The PCT application PCT/IB2018/054684 claims a priority to the U.S. Provisional Patent application Ser. No. 62/524,284 filed on Jun. 23, 2017.

### FIELD OF THE INVENTION

The present invention relates to enterprise software development. More specifically, the present invention provides a method, system, and platform for implementing an Enterprise DevOps Framework to achieve defined business goals.

### BACKGROUND OF THE INVENTION

Currently, numerous traditionally non-technology companies are undergoing a digital transformation. Effective Digital transformation requires re-structuring their Information Technology (IT) and Software Development organizations to run more efficiently and allow for faster innovation. However, large enterprise companies that run IT services have historically partitioned the work between their software development and operations teams, such that the operations team and the development team have inter-dependencies which slows down their ability to deliver new IT services.

In a more traditional development IT operations framework, all application dependencies are the responsibility of IT operations, while the development team is primarily in charge of their own code that is to be deployed. The development team develops service specific code, performs the build and initial testing, and then sends the application to quality assurance (QA). QA then performs manual and automated full product tests. If the application fails, then the application is sent back to the development team, and if the application passes, then the application is sent to IT operations. IT operations then deploys the application in the landing zone, wherein IT operations manages service-specific and service-agnostic infrastructure, and configuration components across the production environment. Further, IT operations manages inspectors for monitoring, logging, and introspecting deployed services and provisions resources for the development team.

By removing inter-dependencies between the development team and IT operations, and by allowing the development team to own more, the IT organization as a whole is able to operate with greater speed and efficiency. Therefore, there is a need for improved systems, methods, platforms, and frameworks that allow the companies to execute more efficiently, thereby accelerating their digital transformation efforts. The present invention aims to place relevant dependencies of the service code in the hands of the development team, while the IT operations manages a service-agnostic landing zone in which services are deployed via pipelines. Inspectors monitor the services in both the pipelines and the landing zone. Furthermore, injectors are introduced in order to inject environment specific information into the service as elements are passed through the pipelines.

### SUMMARY

Disclosed are a method, a system, and a platform for implementing an Enterprise DevOps Framework (EDF).

In some embodiments, a disclosed method enables speedy delivery while reducing the cost of information technology (IT) and improving security of IT services. This process provides a method, which when adopted by a company, will enable them to achieve the benefits.

In some embodiments, a business process is disclosed that allows the companies to execute more efficiently, thereby accelerating their digital transformation efforts.

In some embodiments, disclosed framework includes one or more components including services, pipelines, a landing zone, inspectors, and injectors.

In further embodiments, a service is a code that runs to deliver a very specific value for a defined target audience.

In further embodiments, a service may run on a single or multiple servers. However, the service may be a homogenous piece of software that is designed for a specific outcome(s).

In further embodiments, each service includes the code, the configuration, and the infrastructure that work in tandem for a desired output. The code is the underlying logic behind the service written in a particular programming language(s). The configuration is the prerequisite software that is needed to run the code. The infrastructure is the platform needed to run the service's code and configuration including, but not limited to, servers, databases, and network routers.

In further embodiments, the pipelines include technology-enabled processes for deploying the services in the landing zone.

In further embodiments, unified pipelines deliver all three components of a service, including code, configuration, and infrastructure.

In further embodiments, the landing zone may include service agnostic infrastructure and configuration components. The service runs in the landing zone.

In further embodiments, the landing zone provides two components—Configuration and Infrastructure. The configuration includes software agents needed on all servers that are typically service agnostic. The infrastructure is needed to land any service. The infrastructure may be service agnostic as well and may include components like network, domain name servers, and access management.

In further embodiments, the inspectors are automated tools that log and introspect services in the landing zone and as the services pass the pipelines.

In further embodiments, the injectors are tools that inject environment information to the services in the landing zone and as the services pass pipelines.

In some embodiments, a service delivery process may include delivering services in the service-agnostic landing zone through the help of pipelines. The pipelines package the different components of the service and provision the services and their dependencies in the landing zone.

In some embodiments, the landing zone is service agnostic and the operations team is in charge of the landing zone. Therefore, the operations team does not need to know about the services.

In some embodiments, there is no inter-dependency between the software development team and the operations team.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 illustrates a platform consistent with various embodiments of the present disclosure.

FIG. 2 illustrates a block diagram of an Enterprise DevOps Framework (EDF) in accordance with some embodiments.

FIG. 3 illustrates a flowchart for a method for implementing an EDF in accordance with some embodiments.

FIG. 4 illustrates a block diagram of the components of a selected service from the plurality of services.

FIG. 5 illustrates a flowchart for a method for implementing an EDF in a computer system, in accordance to with some embodiments.

FIG. 6 illustrates a flowchart for the method for implementing the EDF in a computer system, further depicting the steps of packaging and implementing the code, the configuration, and the infrastructure of the selected service.

FIG. 7 illustrates a flowchart for the method for implementing the EDF in a computer system, further depicting the steps of deploying the plurality of inspectors and the plurality of injectors within the landing zone.

FIG. 8 illustrates a flowchart for the method for implementing the EDF in a computer system, further depicting the step of injecting environment specific information into the specific service.

### DETAILED DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of business enterprises, embodiments of the present disclosure are not limited to use only in this context.

Disclosed are a method, a system, and a platform for implementing an Enterprise DevOps Framework (EDF). The EDF allows information technology (IT) development and operations teams to work at full speed and with fewer dependencies. Implementing the EDF, the development team is responsible for developing a plurality of services 202, wherein the development team provides the service code and all the relevant dependencies of the source code. Meanwhile, the operations team is tasked with managing a landing zone 206 in which the plurality of services 202 is deployed. Each of the plurality of services 202 is delivered to the landing zone 206 via a plurality of pipelines 204.

Each of the plurality of pipelines 204 is a process designed specifically to automate the delivery of one or more of the plurality of services 202 into the landing zone 206. A plurality of inspectors 208 and a plurality of injectors 210 are further deployed within the landing zone 206. The plurality of inspectors 208 is a set of tools used to monitor, log, and introspect the plurality of services 202. The plurality of inspectors 208 is used to observe the plurality of services 202 both within the landing zone 206 and as each of the plurality of services 202 is delivered to the landing zone 206 via the plurality of pipelines 204. The plurality of injectors 210 is a set of tools to inject specific environment information into the plurality of services 202. The plurality of injectors 210 may be utilized on the plurality of services 202 within the landing zone 206 or as each of the plurality of services 202 is delivered through the plurality of pipelines 204.

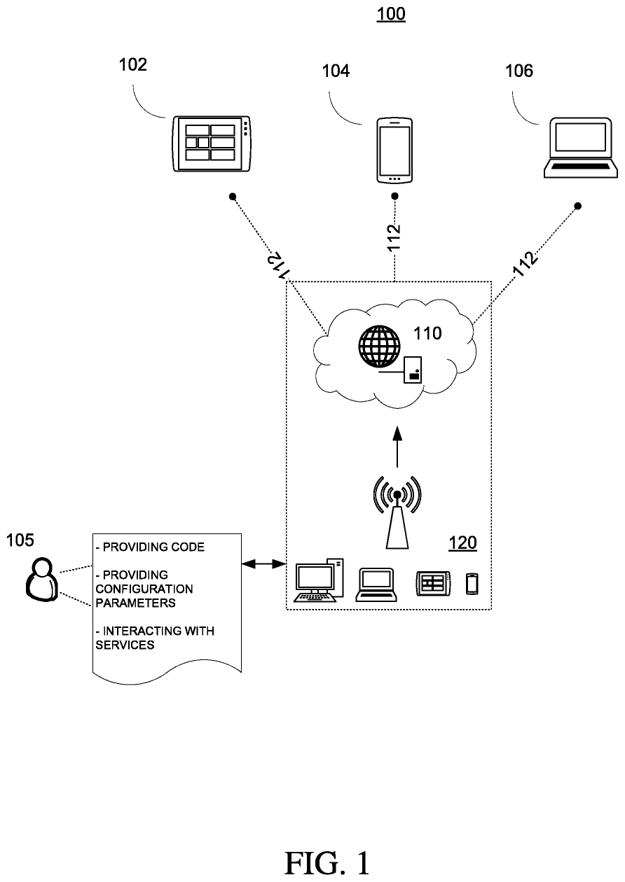

FIG. 1 is an illustration of a platform consistent with various embodiments of the present disclosure. By way of non-limiting example, the platform 100 for implementing the EDF may be hosted on a centralized server 110, such as, for example, a cloud computing service. The centralized server 110 may communicate with other network entities, such as, for example, a mobile device (such as a smartphone, a laptop, a tablet computer etc.) and other electronic devices (such as desktop computers, etc.) over a communication network 112, such as, but not limited to, the Internet.

Further, users of the platform may include one or more relevant parties such as, members of software development team, members of operation team, and administrators of the disclosed system and platform. Accordingly, electronic devices operated by the one or more relevant parties may be in communication with the platform. For example, the platform may be in communication with a development team member electronic device 102 operated by a development team member, an operation team member electronic device 104 operated by an operation team member, and an administrator electronic device 106 operated by an administrator of the disclosed system and platform.

A user 105, such as the one or more relevant parties, may access platform 100 through a software application. The software application may be embodied as, for example, but not be limited to, a website, a web application, a desktop application, and a mobile application compatible with a computing device 120. Accordingly, in an instance, the user 105 may be a software developer that may provide code 402 for one or more of the plurality of services 202.

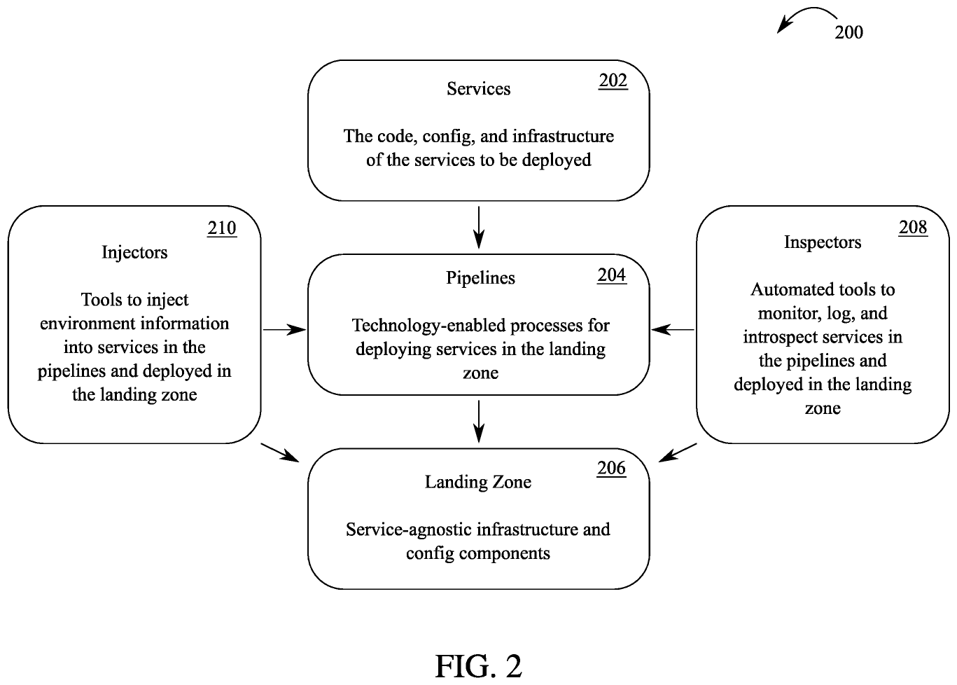

Turning to FIG. 2, a block diagram of a framework 200 for implementing the EDF in accordance with some embodiments. The framework 200 consists of five components including the plurality of services 202, the plurality of pipelines 204, the plurality of inspectors 208, the landing zone 206, and the plurality of injectors 210.

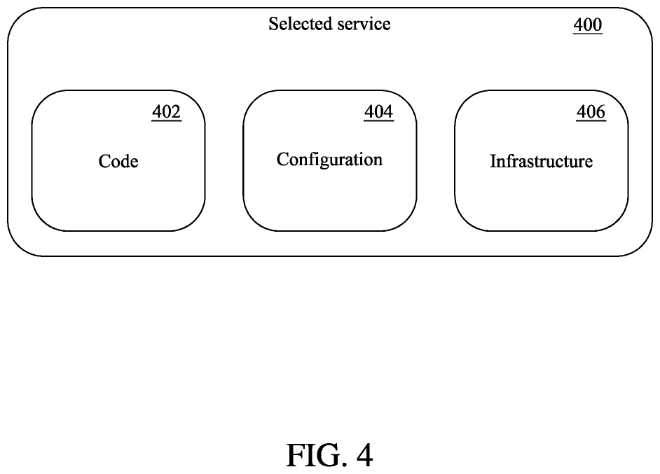

Each of the plurality of services 202 is a piece of code 402 or software that runs to deliver a very specific value for a defined target audience. The plurality of services 202 can be run on a single server or multiple servers. Whether run on one server or on multiple servers, each of the plurality of services 202 may be a homogenous piece of software that is designed for a specific outcome(s). In reference to FIG. 4, each of the plurality of services 202 comprises a code 402, a configuration 404, and an infrastructure 406, wherein the code 402, the configuration 404, and the infrastructure 406 are layers that work in tandem for a desired output. Therefore, the code 402, the configuration 404, and the infrastructure 406 for a selected service 400 from the plurality of services 202 form the service specific components of the selected service 400. The code 402 is the underlying logic behind the selected service 400 and is written in a particular programming language(s). Meanwhile, the configuration 404 is a prerequisite software that is needed to run the code 402. The infrastructure 406 is the platform needed to run the code 402 and the configuration 404 of the selected service 400, including but not limited to servers, databases, and tools that create virtual machines. Each of the plurality of services 202 may be landing zone agnostic.

The plurality of pipelines 204 includes technology-enabled processes for deploying the plurality of services 202 in the landing zone 206. Each of the plurality of pipelines 204 is a process designed to specifically automate the delivery of one or more of the plurality of services 202 into the landing zone 206. The plurality of pipelines 204 delivers all three components of the selected service 400, including the code 402, the configuration 404, and the infrastructure 406. The computing processes carried out by each of the plurality of pipelines 204 may include commands, program runs, tasks, threads, procedures, etc.

Once delivered by the plurality of pipelines 204, each of the plurality of services 202 runs in the landing zone 206. The landing zone 206 is focused on catching service agnostic components, as the service agnostic components are delivered via the plurality of pipelines 204. As such, the landing zone 206 includes a landing zone infrastructure and a landing zone configuration, wherein both the landing zone infrastructure and the landing zone configuration may be service agnostic. The landing zone configuration comprises one or more components that may include software agents needed on the one or more servers. Typically the one or more components of the landing zone configuration are service agnostic. The one or more components may include, but are not limited to, components like anti-virus, logging, and monitoring. The landing zone infrastructure is the overall infrastructure 406 needed to land any of the plurality of services 202. The landing zone infrastructure is service agnostic as well and includes components like network and access management.

The plurality of inspectors 208 is deployed within the landing zone 206, wherein the plurality of inspectors 208 monitors, logs, and introspects the plurality of services 202 pre- and post-deployment. The plurality of inspectors 208 includes automated tools that monitor, log, and introspect the plurality of services 202 as each of the plurality of services 202 is delivered through the plurality of pipelines 204. Inspection of the plurality of services 202 as the plurality of services 202 move through the plurality of pipelines 204 may include processes such as security inspection and audit checks. Further, the plurality of inspectors 208 includes automated tools that monitor, log, and introspect the plurality of services 202 within the landing zone 206. Inspection of the plurality of services 202 within the landing zone 206 may include processes such as image analysis on containers to check for available software on the container.

Similar to the plurality of inspectors 208, the plurality of injectors 210 is deployed within the landing zone 206, wherein the plurality of injectors 210 injects environment information into the plurality of services 202 pre- and post-deployment. The plurality of injectors 210 includes tools that inject environment specific information into each of the plurality of services 202 as each of the plurality of services 202 processes through the plurality of pipelines 204. Further, the plurality of injectors 210 includes tools that inject the environment specific information into the plurality of services 202 within the landing zone 206. In an exemplary embodiment, the plurality of injectors 210 may be used to insert a subnet identification (ID) into the one or more of the plurality of services 202.

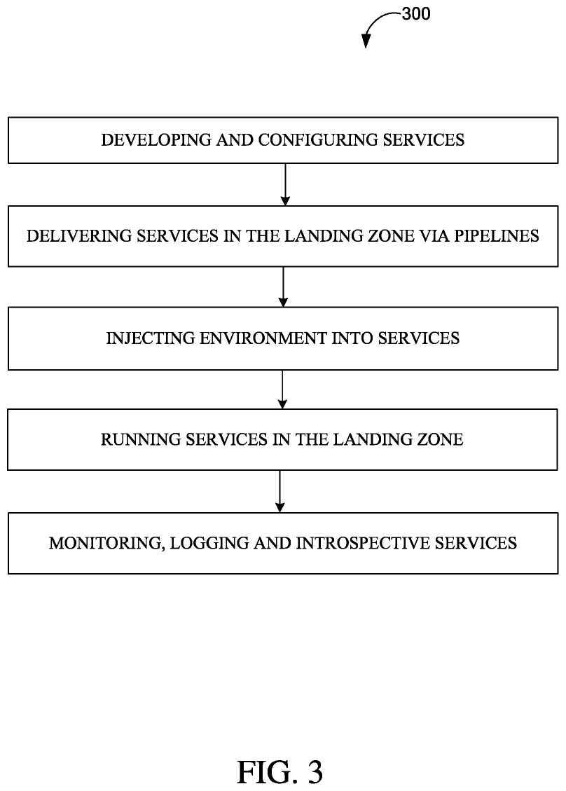

FIG. 3 illustrates a flowchart for a method 300 for implementing the EDF in accordance with some embodiments. The method 300 includes developing and deploying the plurality of services 202. The software development team may be involved in developing and configuring the plurality of services 202. Further, the method 300 includes delivering the plurality of services 202 in the landing zone 206 via the plurality of pipelines 204. The plurality of pipelines 204 package the different components of each of the plurality of services 202 and provision the plurality of services 202 and each of the corresponding dependencies in the landing zone 206. The operations team may be in charge of the landing zone 206. However, the operations team does not need to know about the plurality of services 202, wherein the landing zone 206 is service agnostic. Similarly, each of the plurality of services 202 is landing zone agnostic, therefore there is no inter-dependency between the software development team and the operations team.

Yet further, the method 300 includes injecting the environment specific information into the plurality of services 202. Moreover, the method 300 includes running the plurality of services 202 in the landing zone 206. Further, the method 300 includes monitoring, logging, and introspecting the plurality of services 202 running in the landing zone 206.

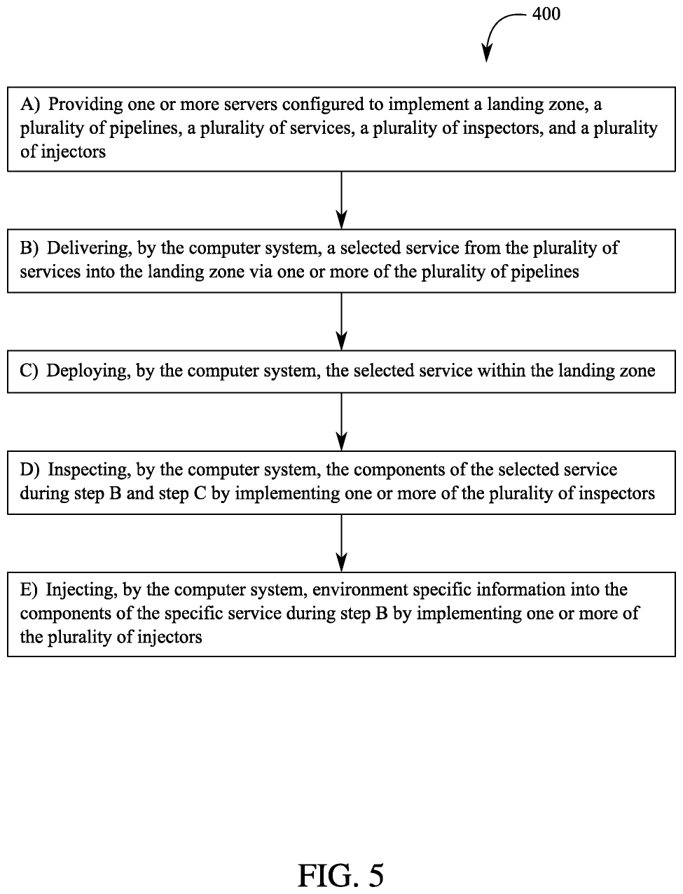

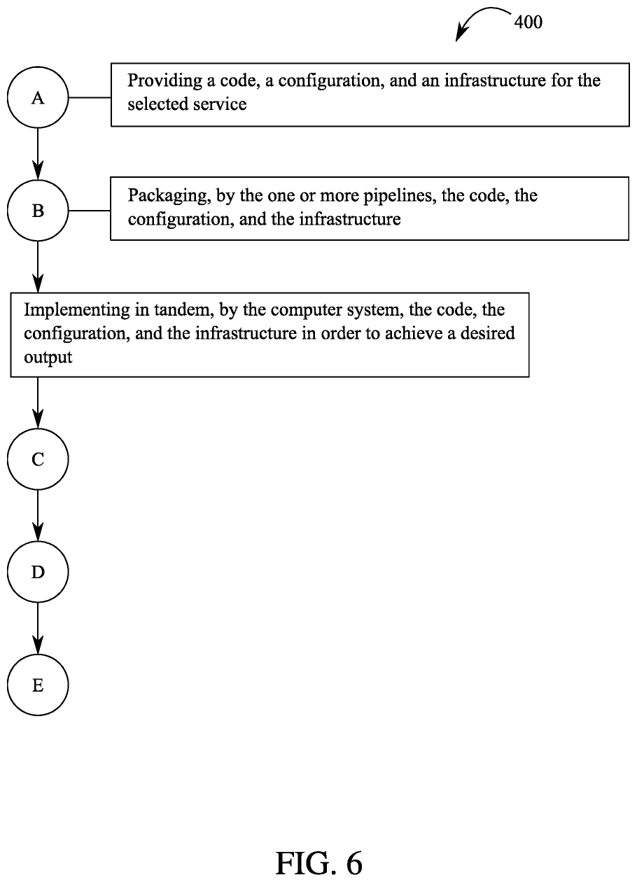

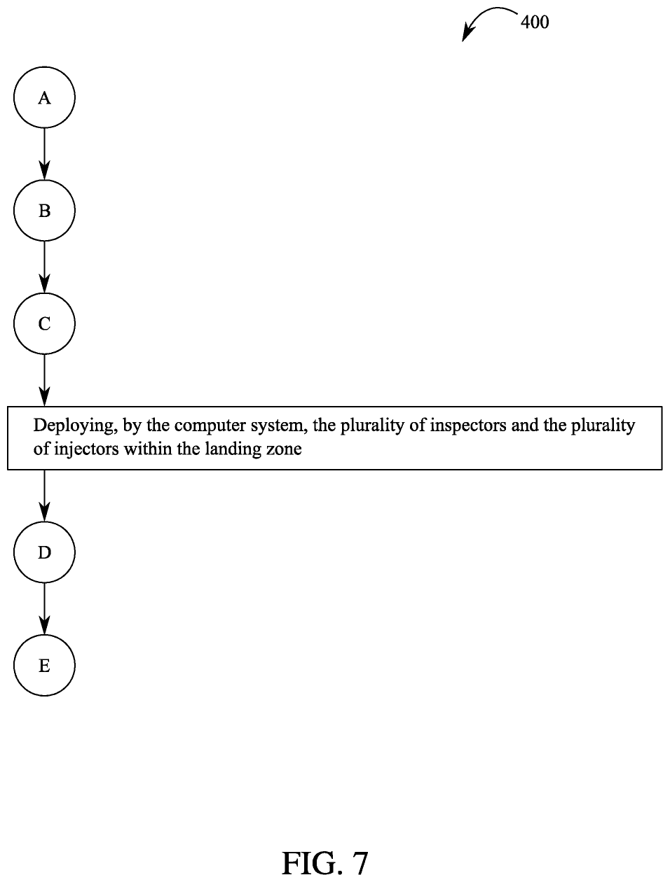

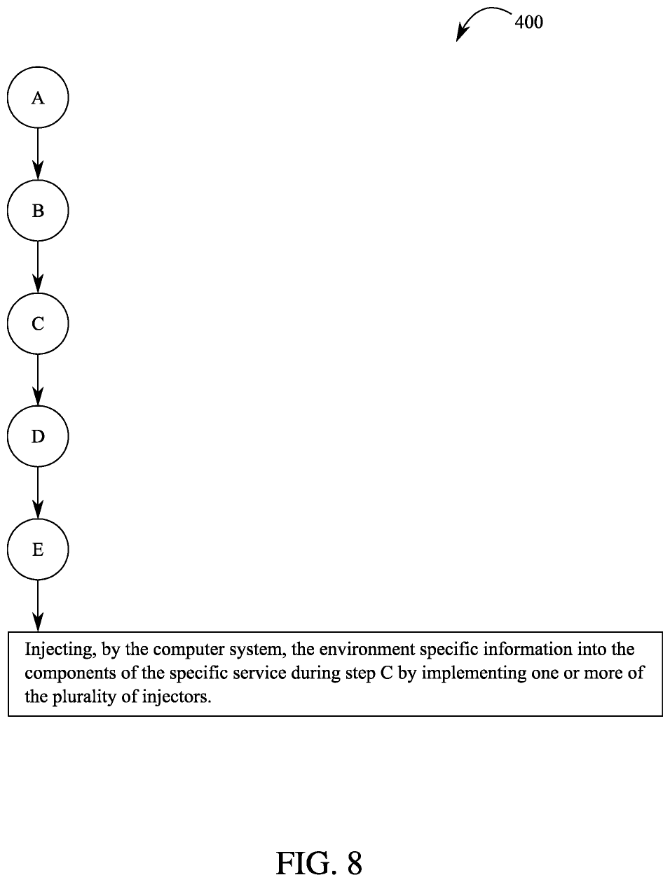

FIG. 5-8 illustrate a flowchart for a method 400 for implementing the EDF in a computer system, in accordance with some embodiments. The method 400 includes providing one or more servers configured to implement the landing zone 206, the plurality of pipelines 204, the plurality of services 202, the plurality of inspectors 208, and the plurality of injectors 210. The plurality of services 202 may be developed by the software development team, wherein the software development team provides the code 402, the configuration 404, and the infrastructure 406 for each of the plurality of services 202. The method 400 includes delivering, by the computer system, the selected service 400 from the plurality of services 202 into the landing zone 206 via one or more of the plurality of pipelines 204. The one or more of the plurality of pipelines 204 packages the code 402, the configuration 404, and the infrastructure 406 for the selected service 400, wherein the computer system implements the code 402, the configuration 404, and the infrastructure 406 of the selected service 400 in tandem to achieve a desired output. Further, the method 400 includes deploying, by the computer system, the selected service 400 within the landing zone 206.

The method 400 may further include deploying, by the computer system, the plurality of inspectors 208 and the plurality of injectors 210 within the landing zone 206. The computer system may inspect the components of the selected service 400 as the selected service 400 is delivered through the plurality of pipelines 204 or deployed within the landing zone 206, wherein the computer system implements one or more of the plurality of inspectors 208 to inspect the selected service 400. The computer system may also inject the environment specific information into the components of the specific service as the selected service 400 is delivered through the plurality of pipelines 204 or deployed within the landing zone 206, wherein the computer system implements one or more of the plurality of injectors 210 to insert the environment specific information into the selected service 400.

The method 400 may include accessing the one or more servers through a software application in order to deploy one or more of the plurality of services 202, one or more of the inspectors, or one or more of the injectors. The selected service 400 may be a homogenous piece of software implemented across the one or more servers. Furthermore, the selected service 400 may be designed to produce a specific outcome within the landing zone 206.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

It will be appreciated that various above-disclosed embodiments, other features, and functions, or alternatives thereof, may be desirably combined into many other different systems or applications. Various presently unforeseen or unanticipated alternatives, modifications, variations, or improvements therein may be subsequently made by those skilled in the art.

What is claimed is:

1. A method for implementing an Enterprise DevOps Framework (EDF) in a computer system, the method comprises the steps of:
A) providing one or more servers configured to implement a landing zone, a plurality of pipelines, a plurality of services, a plurality of inspectors, and a plurality of injectors;
B) delivering, by the computer system, a selected service from the plurality of services into the landing zone via one or more of the plurality of pipelines;
C) deploying, by the computer system, the selected service within the landing zone;
D) inspecting, by the computer system, the components of the selected service during step B and step C by implementing one or more of the plurality of inspectors; and
E) injecting, by the computer system, environment specific information into the components of the specific service during step B by implementing one or more of the plurality of injectors.

2. The method for implementing an Enterprise DevOps Framework (EDF) in a computer system, the method as claimed in claim 1 further comprises the steps of:
injecting, by the computer system, the environment specific information into the components of the specific service during step C by implementing one or more of the plurality of injectors.

3. The method for implementing an Enterprise DevOps Framework (EDF) in a computer system, the method as claimed in claim 1 further comprises the steps of:
providing a code, a configuration, and an infrastructure for the selected service; and
packaging, by the one or more pipelines, the code, the configuration, and the infrastructure.

4. The method for implementing an Enterprise DevOps Framework (EDF) in a computer system, the method as claimed in claim 1 further comprises the steps of:
providing a code, a configuration, and an infrastructure for the selected service; and
implementing in tandem, by the computer system, the code, the configuration, and the infrastructure in order to achieve a desired output.

5. The method for implementing an Enterprise DevOps Framework (EDF) in a computer system, the method as claimed in claim 1 further comprises the step of:
deploying, by the computer system, the plurality of inspectors within the landing zone.

6. The method for implementing an Enterprise DevOps Framework (EDF) in a computer system, the method as claimed in claim 1 further comprises the step of:
deploying, by the computer system, the plurality of injectors within the landing zone.

7. The method for implementing an Enterprise DevOps Framework (EDF) in a computer system, the method as claimed in claim 1, wherein each of the plurality of services is landing zone agnostic.

8. The method for implementing an Enterprise DevOps Framework (EDF) in a computer system, the method as claimed in claim 1, wherein the landing zone is service agnostic.

9. The method for implementing an Enterprise DevOps Framework (EDF) in a computer system, the method as claimed in claim 1, wherein the one or more servers is accessible through a software application.

10. The method for implementing an Enterprise DevOps Framework (EDF) in a computer system, the method as claimed in claim 1, wherein each of the plurality of services includes a code, a configuration, and an infrastructure.

11. The method for implementing an Enterprise DevOps Framework (EDF) in a computer system, the method as claimed in claim 10, wherein the code is underlying logic written in a particular programming language.

12. The method for implementing an Enterprise DevOps Framework (EDF) in a computer system, the method as claimed in claim 10, wherein the configuration is prerequisite software for running the code.

13. The method for implementing an Enterprise DevOps Framework (EDF) in a computer system, the method as claimed in claim 10, wherein the infrastructure is a platform for running both the code and the configuration.

14. The method for implementing an Enterprise DevOps Framework (EDF) in a computer system, the method as claimed in claim 1, wherein the landing zone includes a landing zone configuration and a landing zone infrastructure.

15. The method for implementing an Enterprise DevOps Framework (EDF) in a computer system, the method as claimed in claim 14, wherein the landing zone configuration includes software agents needed on the one or more servers.

16. The method for implementing an Enterprise DevOps Framework (EDF) in a computer system, the method as claimed in claim 14, wherein the landing zone configuration is service agnostic.

17. The method for implementing an Enterprise DevOps Framework (EDF) in a computer system, the method as claimed in claim 14, wherein the landing zone infrastructure includes components needed to land the plurality of services.

18. The method for implementing an Enterprise DevOps Framework (EDF) in a computer system, the method as claimed in claim 14, wherein the landing zone infrastructure is service agnostic.

19. The method for implementing an Enterprise DevOps Framework (EDF) in a computer system, the method as claimed in claim 1, wherein the selected service is a homogenous piece of software.

20. The method for implementing an Enterprise DevOps Framework (EDF) in a computer system, the method as claimed in claim 1, wherein the selected service is designed for a specific outcome.
